(19) United States
(12) Patent Application Publication
(10) Pub. No.: US 2014/0061169 A1
(43) Pub. Date: Mar. 6, 2014

(54) USER INTERFACE FOR WELDING EQUIPMENT AND SYSTEMS

(71) Applicant: Illinois Tool Works Inc., Glenview, IL (US)

(72) Inventors: Michael A. Sammons, Appleton, WI (US); Jeff M. Herb, Appleton, WI (US); James R. Totzke, Appleton, WI (US); Jon M. Patterson, Appleton, WI (US); Ashok Darisipudi, Aurora, IL (US)

(21) Appl. No.: 13/973,137

(22) Filed: Aug. 22, 2013

Related U.S. Application Data
(60) Provisional application No. 61/694,563, filed on Aug. 29, 2012.

(51) Int. Cl. B23K 11/24

(52) U.S. Cl. CPC B23K 11/24
USPC 219/109

(57) ABSTRACT

A user interface for welding equipment is disclosed. The user interface comprises an architecture which organizes different types of welding controls into pre-defined categories or zones. The zones are arranged in a layout on the interface to provide access to easily see and adjust important weld parameters, particularly weld heat. Main displays and basic heat controls are provided in an upper portion of the display, while less frequently used controls are provided lower in the display, and to the side of the display. Electronic and graphic displays are arranged in levels, providing a limited number of layers, and can be associated with multi-dimensional navigational devices and home buttons to allow for easy navigation through the display.

### CROSS-REFERENCE TO RELATED APPLICATIONS

This application claims the benefit of U.S. Provisional patent application Ser. No. 61/694,563 filed on Aug. 29, 2012 and titled “User Interface for Welding Equipment and Systems”, which is hereby incorporated by reference in its entirety.

### BACKGROUND

The disclosure is directed to a user interface for welding equipment, and more particularly to an architecture and layout for an interface for use on various types of welding equipment and systems.

Typical welding power sources and machines are complicated, technical devices, which expect commands in exact, technical terms.

Typical welding operators, however, view welding as a craft, not a science. Welders view the act of welding as an experiential process which is learned by doing—using incremental trial-and-error to build knowledge, and to develop personal styles and preferences. As a result, welders often work experimentally, within a range rather than at a specific value, tweaking and adjusting to “get it right”. Welders talk about the right “sound” or “feel” of laying a bead. A correct weld is typically judged by the experience or the sensation, which welders typically can't explain by words or numbers. As a result, there can be a cognitive disconnect between the welding machines and the people who use them.

Although the user interfaces on a typical welding machine frequently provide the capability to change the parameters that welders want to change, moreover, there is often a disconnect between what the welder is looking for and the technical language of the machine. This disconnect causes frustration, limits understanding, and ultimately impacts a user's efficiency.

Further, although welders like to experience and explore a weld, external factors (production goals, equipment limits, limited resources, etc) and a lack of available welding engineers and welders mean that welders don't always have spare time or freedom to play. Experiential learning can also be limited because welders find welding machines difficult and intimidating to explore. A lack of hierarchy of controls, unclear starting points, confusion about how different parameters affect the outcome and hidden or hard-to-find features all discourage exploration.

Typical welding interfaces can also present barriers to refining and personalizing. Parameters, for example, often lack clear bounds and ranges. Units and increments lack meaning and consistency, and it can be difficult to determine one's current settings. Enabling quick refinement and supporting personal preferences can enable welders to perform better and thus build a more positive emotional experience with a piece of equipment.

The present invention addresses these and other issues by providing a user interface for a welding system that, in part, bridges this gap between the human and the machine.

### SUMMARY

In one aspect, the present invention provides a welding user interface system architecture and layout that guides the organization, relationships, and hierarchy between controls in a variety of systems, ranging from basic welding machines to automated systems, providing an intuitive flow of interactions for welders using the machines. The consistent architecture allows users at many levels—operators, managers, distributors and sales personnel—to easily interact with different machines. By providing a consistent intuitive display, users can easily move between machines, transition between processes, discover new capabilities, and educate themselves on new machines and processes quickly. The architecture and layout can be applied to both tangible and graphical user interfaces, providing consistent physical interactions and visualizations. The architecture and layout can also be intuitively used by different people with very different goals and levels of understanding.

In another aspect, the architecture and layout of the interface can allow any user to get started quickly regardless of their objective, while providing a non-intimidating interface that is easy to understand. A clear hierarchy of controls, meaningful groupings of controls, straightforward navigation, and approachable design enables multiple entry points for users.

In still another aspect, the interface enables simplified changes to the welding parameters, enabling the weld to be adjusted for multiple users, and for differing goals and needs through a shift or day. The architecture and interface enables a user to adjust the welding machine without memorizing a path, or spending significant time locating a starting point in the interface. The interface also quickly guides users to weldable starting settings, and then allows them to fine tune the weld, enabling better welding without sacrificing user control. The architecture also provides clear status and option information to the user, including overviews, ranges, endpoints, and a clear information hierarchy. To ease selections, the interface can also provide multiple types of information like labels, icons, color, placement, and groupings to help users understand what each control will do.

In an additional aspect, user-centered language is used for inputs while providing technical feedback about what the machine is doing. Inputs and feedback can include physical terms like material and thickness, arc shape and feel, and weld characteristics, and can be provided using meaningful metrics and easily communicable settings. The inputs and feedback, moreover, can be in a user selected language, such as English, Italian, French, or Spanish.

In an additional aspect, the disclosure provides an architecture for a user interface for use in welding equipment. The architecture includes a number of defined zones, including a main display zone, a basic controls zone, an advanced controls zone, an advisory information zone, an operational controls zone, and a power zone. The zones are arranged in a layout which enables easier access to more frequently used elements. Therefore, the main display and basic controls zones can be advantageously provided in an upper interface portion to provide easy access to view and change weld heat data, the advanced control zone and the advisory information zone can be provided in a central interface portion below and adjacent the upper interface portion, and the operational controls zone and the power zone are located in a lower interface portion below and adjacent the central interface portion. A power control is provided in the power zone in the lower interface portion and the lower interface is adapted to selectively receive an operational control in the operational control zone. The central interface is adapted to selectively receive at least one of an advisor control in the advisory information zone, and advanced control in the advanced control zone. A heat control is provided in the basic controls zone in the upper interface zone, and the upper interface zone is adapted to selectively receive a display element in the main display zone.

The architecture can also include a setup zone provided in at least one of the upper interface area and the central interface area, and the interface is adapted to receive a setup control in the setup zone. The setup control can, for example, select a welding process to be used by the welding equipment, and can be provided on a switch or other actuator providing control signals to underlying control circuitry The architecture can also include a memory zone provided in the upper interface area and adapted to receive a memory control for accessing weld parameter settings either stored in the welding equipment or in a memory accessible to the welding equipment. The architecture can also include a machine management zone provided in a central portion of the display, and adapted to receive a machine management control providing access to at least one of a weld parameter limit, a log and a lock.

In another aspect, the advanced control can comprise a three level display including a metadata category, a sub category, and a parameter category. The advanced control can also include a multi-directional navigational control for navigating between and selecting data in the metadata category, the sub category, and the parameter category. The architecture of the electronic display can include a home button providing a signal to internal circuitry to return a user to the metadata category. In yet another aspect, the electronic display can also include the advisor control.

In another aspect, the welding equipment using the interface having the disclosed architecture can be at least one of a welding power source, a wire feeder, a remote control device, a welding gun, a welding torch, and a welding automation controller.

In still another aspect, the basic control in the disclosed architecture comprises a control knob substantially centered in the upper portion of the interface and adapted to be adjusted by a user to change a weld heat of a corresponding weld power source.

In another aspect of the invention, a user interface for use in welding equipment comprising is disclosed comprising an electronic display for displaying weld selection data in a primary metadata level, a secondary sub category level, and a tertiary parameter level, each weld selection in the sub category corresponding to at least one corresponding weld selection in the metadata level, and each weld selection in the tertiary parameter level corresponding to at least one weld selection in the corresponding sub category level. A selector control activatable by a user to selecting a weld selection in the electronic display is provided adjacent the display. A home button is also provided adjacent the display, the home button being activatable by a user to selectively return the electronic display to the primary level metadata. The user interface can also include a navigational device activatable by the user for moving through the primary metadata level, the secondary sub category level, and the tertiary parameter level and corresponding weld selection data in the electronic display and identifying a weld selection for selection by the selector control, the navigational device being positioned adjacent the electronic display. The navigational device can be a multi-directional switch positioned adjacent the electronic display, each of the positions of the multidirectional switch corresponding to a selected direction of movement in the electronic display. For example, the multi-directional switch can comprise four positions, the four positions corresponding to an up direction, a down direction, a right direction, and a left direction activated to indicate movement through the interface.

In another aspect, the present disclosure provides a user interface for a welding system, including an upper, central, and lower section. The interface includes an upper portion that provides a heat control and at least one of a user display, a memory component, and a setup control. The central portion comprises at least one of an advanced control for weld sequence data, and an advisory control for providing a suggested weldable condition to a welder. The lower portion comprises at least one of an operational control for providing remote functions for a welding power source or a peripheral component and a power control for activating the welding system.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a perspective view of a welding system including a welding power source, wire feeder, and other components that can be used with the disclosed user interface.

FIG. 2 is a schematic illustrating an architecture of welding controls for use the welding equipment user interface described in the disclosure.

FIGS. 3A and 3B are schematic illustrations of a layout for the architecture of FIG. 2, the layout comprising upper, central and lower areas of an interface including defined zones for selectively providing control elements corresponding to the zones.

FIGS. 4, 5, and 6 illustrate elements of the upper interface area of FIG. 3A.

FIGS. 7-10 illustrate electronic and graphic interfaces for use with the architecture described above.

FIGS. 11A and 11B illustrate the architecture and layout of FIGS. 2, 3A, and 3B as applied to a basic welding user interface.

FIG. 12 illustrates illustrate the architecture and layout of FIGS. 2, 3A, and 3B as applied to a more complex welding user interface.

FIG. 13 illustrates illustrate the architecture and layout of FIGS. 2, 3A, and 3B as applied to an advanced welding user interface including an advanced display.

FIGS. 14-16 illustrate the electronic interface and aspects of moving through the interface with navigational and home controls.

### DESCRIPTION

A typical welding system includes a welding power source and a torch or gun, and can include a number of other components, including a wire feeder, water re-circulators, running gear, gas supply and corresponding valve, and remote control devices. Remote control devices typically provide the ability to start and stop a weld, select programs, control auxiliary equipment, and adjust weld parameters setting, such as voltage, amperage, and wire feed speed. Components of the welding system can also be connected to fixed and flexible automation devices including turntables, gantries, booms, side beams and robots.

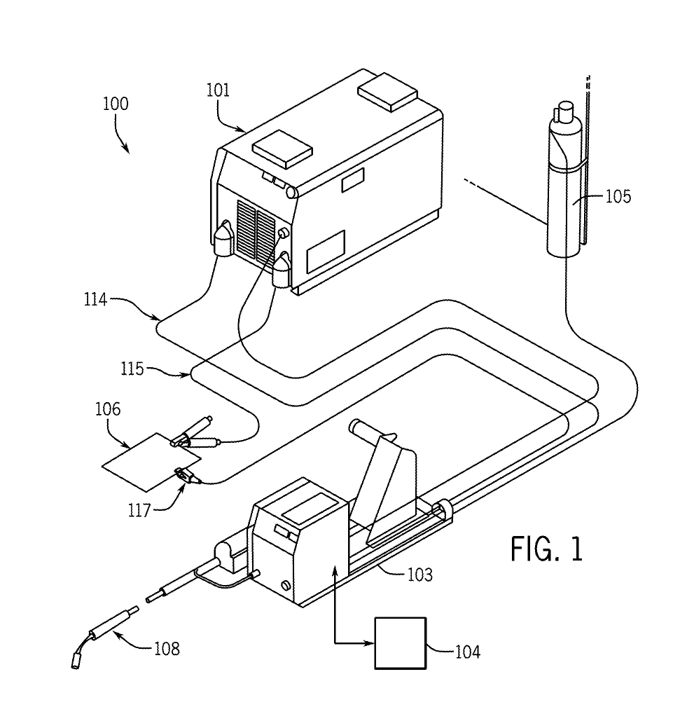

One embodiment of welding system 100 is illustrated FIG. 1, by way of example. Here, the welding system includes a welding power source 101, a wire feeder 103, a wire feed remote controller 104, and a source of gas 105 which cooperate to provide welding power to a gun or torch 108, for welding a work piece 106.

The welding power source 101 includes internal control circuitry to provide weld power on cables 114 and 115. Voltage feedback may be provided from clamp 117. Current feedback may be obtained from a feedback circuit, such as a shunt and associated circuiting within power source 101 or wire feeder 103 (not shown). Controller(s) for the welding system 100 may reside in power source 101, wire feeder 103, both, external to both, or a combination thereof. The system may be housed in a single housing, or in a number of housings.

A user interface is typically provided on the front of the welding power source, and can also be provided in one or more of the other components including, as shown here for example, the wire feeder. User interfaces can also be provided on a remote control device, an automation system controller, on robot interface, or in other peripheral components. Commands to the various components in the system can be provided through wired or wireless communication systems, as discussed below.

The controls and displays provided on the interface provide commands and receive feedback for display from internal control circuitry in the welding power source or other equipment. The equipment and corresponding interface can vary significantly between a basic manual welding system which can use simple rheostat or simple up/down controls, and an automated welding system which can use advanced digital controls to set weld command values including weld volts, weld amps, and wire feed speed and can also control timing for activating weld controls, gas valves, wire feed systems, and other peripherals. The system architecture described below provides intuitive groupings of control settings, and a layout of control features which can be consistently applied across varying types of machines to allow an operator or management personnel to easily locate controls irrespective of the complexity of the system or other specific types of controls being implemented. In a typical system of the type described above, the system architecture described below can advantageously be provided on a single user interface in a selected piece of equipment and used to control various pieces of equipment connected in the system, although user interfaces constructed using the defined system architecture can also be provided on two or more pieces of equipment in the system.

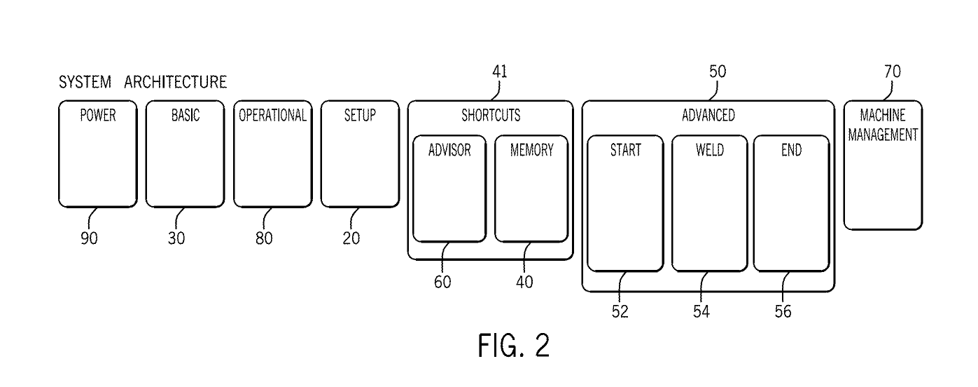

Referring now to FIG. 2, one embodiment of a system architecture for a user interface that can be applied across a range of different welding machines and installations of varying complexities is illustrated. The exemplary architecture divides the controls that are used by a welding operator or management personnel into a plurality of defined categories or zones which can be provided on a user interface. Each of these categories can include a plurality of different grouped features which can be selectively accessed for adjustment. The features can be provided through traditional controls (knobs, switches, buttons), or on a display screen (LCD, LED, or other similar types of displays, including touch screens and field effects displays), and can be nested using menus, which are accessed through specific keys or groupings of keys, including physical keys, infrared technology, through passwords or codes or in other ways known to those skilled in the art. The categories of controls and features provided on the user interface of any given welding machine or power source, wire feeder, or remote device, can vary based upon the complexity of the machine, as described below. As shown here, controls can include on/off power 90, basic controls 30, operational controls 80, and setup controls 20. More complex advisor 60 and memory functions 40 are also available, as well as advanced functions 50, and machine management 70. Each of these is described more fully below.

The layout of the controls on the user interface can be adapted to different levels of machines ranging between basic manual welding power sources and automation equipment, and on various types of welding equipment including welding power sources, wire feeders, automation controllers, and other devices. The number of categories and the capabilities of the interface can be varied depending on the capability and type of the machine.

In each interface, important common controls and information needed for basic use can be positioned where these controls are easily accessed, and can advantageously be positioned towards the top of the interface, in a prominent and visible location.

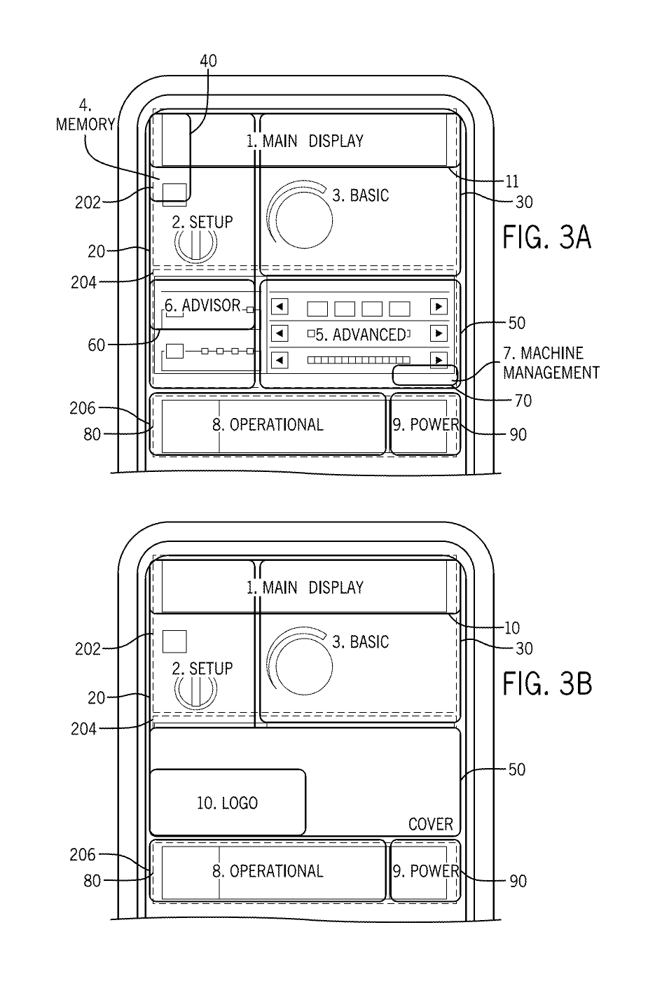

Advanced 50 and less commonly used controls and information can be positioned in a less prominent position, towards the side of the basic controls 30, or advantageously below the basic controls section. This area can also be covered with a panel or similar devices to protect and simplify the interface, as shown in FIG. 3B. Basic machines typically will not require these controls, and this section can be left blank in those interfaces.

Operational controls 80 and power 90 are preferably positioned in a lower portion of the interface, where the controls are more closely linked with other machine interactions.

Additionally, the controls that are used most frequently can be positioned toward the center, where they can be easily reached, and those that are used less frequently at the periphery of the interface. The user interface layout can remain substantially the same in both simple and more advanced welding systems.

This general layout can be provided in a traditional, tangible user interface, which employs hard wired switches, analog controls like potentiometers, and simple controls and gauges, or adapted for use in LED and LCD displays, ranging from multi-segment LED displays, LED and LCD bar graphs/scales, and full electronic graphic user interface displays, as described below. In each case, the relative position of the various categories of information can be maintained, thereby enabling a user to easily move between basic, manual welding installations, and semi and fully automatic installations with relative ease. The controls can be mounted in a single interface component, or can be separately arranged on corresponding components which can be interconnected to form an interface.

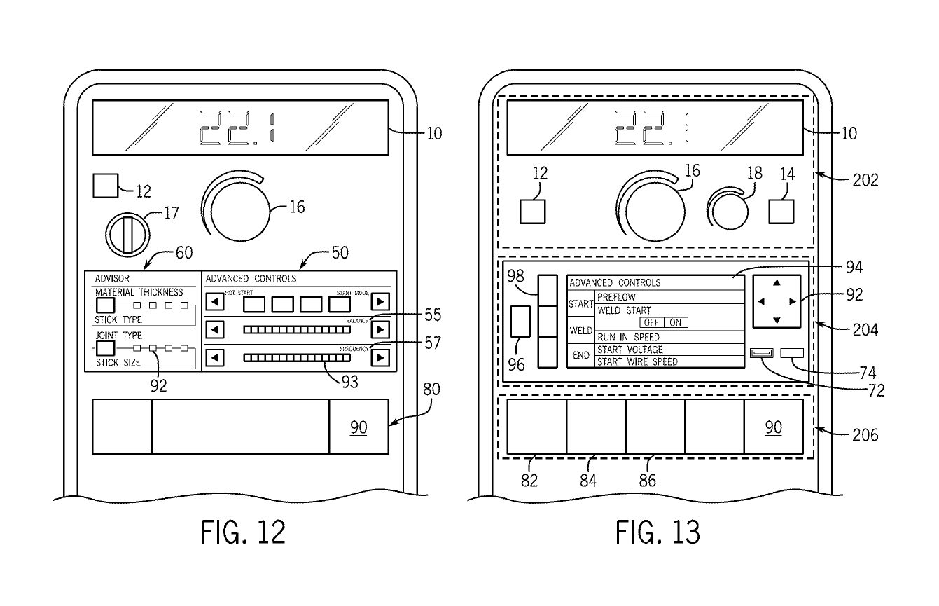

Referring now to FIGS. 3A and 3B, there can be, as shown here, ten zones in the layout largely corresponding to the groupings of the system architecture (main display 10, setup 20, basic 30, memory 40, advanced 50, advisor 60, machine management 70, operational 80, power 90, and cover/logo). Depending on the feature set of each machine, the number of zones and their sizing on the interface can change. A consistent relative placement of the zones across equipment can be maintained to provide continuity as a user moves between different types of welding installations. As shown in FIGS. 3A, 3B and FIG. 13, the zones are aligned in an upper interface area 202, central interface area 204, and lower interface area 206. FIG. 3A illustrates a full featured machine, while FIG. 3B illustrate a more basic machine with fewer zones. In each case controls corresponding to the selected zones are received in the interface in the selected zone. As shown in FIG. 3B, in some applications, covers can be advantageously positioned over selected controls (here, the central interface area 204) to limit access or protect the underlying interface. Where specific features are not required, these areas can also be left blank, or a removable panel can be provided to receive the corresponding controls in an upgrade to the welding equipment. Here, for example, the inserted components can be connected to corresponding connectors in a wiring harness or circuit board in the welding equipment.

Upper Interface Area

The upper interface area 202 includes display elements and frequently accessed controls, including those that can be used during a weld, and those that are useful for quickly retrieving stored weld parameters. By providing appropriate display elements in an upper portion of the interface, users are able to visually acquire an overview of how a machine is currently set without needing to cycle through setup. The overview can include basic 30 “heat” information (volts, amps, wire feed speed), as well as setup parameters 20 (material, wire type, etc.) and process information (MIG, TIG, Stick, etc.), or memory 40. Where there is no electronic display, analog knobs can include clear indicators including graphics that communicate their current settings such as numerical indicators or color-coded ranges. The selection knobs, such as, for example, a process selector knob or a heat control knob, can be locked into position at its current setting to enable a user to easily view the setting.

Basic control weld parameters, like amps, volts and wire feed speed are preferably visible from several feet, allowing a user to check their settings from where they are welding without needing to walk over to the machine. In some applications, for example, visibility from as far as thirty feet can be advantageous. The basic controls including a heat control and corresponding setting are preferably visible, as is the memory indicator, when applicable. Although a number of lighted displays can be used, red LEDs/LCDs have been shown to be the most easily read from a distance.

The upper interface area 202 includes a number of different “zones” that correlate with the system architecture described above, and which can be selectively provided on an interface with corresponding control elements.

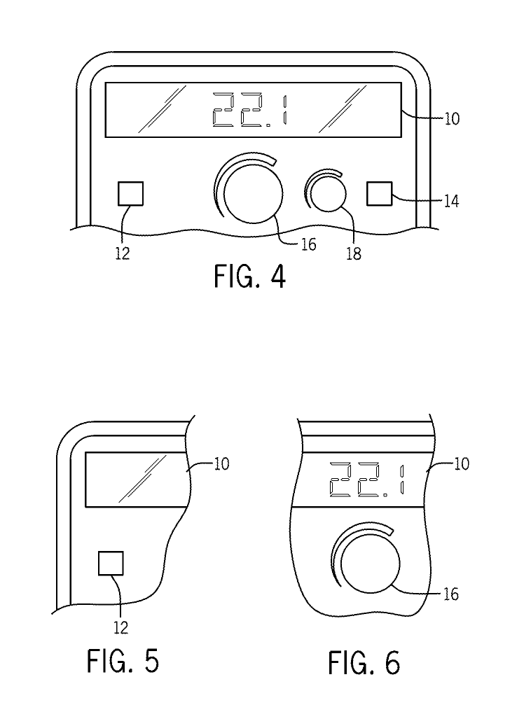

Zone 1: Main Display
The main display 10 is for top-level information, and allows a welding operator or manager to quickly view data necessary to define the current welding parameters, including setup overview, basic control settings and memory status. For analog machines, this information can be integrated into the controls in Zones 2 (setup 20), 3 (basic 30) and 4 (memory 40). Typical elements are illustrated in attached FIGS. 4-6. For example, the basic control settings can be shown in a graphic provided around a potentiometer or other control 16, 18. In one embodiment, for example, a two-colored range indicator can be provided, with a first color (for example, blue) illustrating the full range, and a second color (for example, red) illustrating the selected setting within the range. Numerical ranges, color ranges, or other types of identification could also be used. The elements can include a main display 10 that extends across the upper portion of the interface and that displays either a single welding parameter or multiple welding parameters. The welding parameters can include a welding process type, material, wire, and gas; basic 30 control settings such as a weld voltage or amperage level, and a wire feed speed. Amperage, or other actual or command values, can also be displayed depending on the type of weld process selected. In some applications a program from memory 40 can also be displayed. Buttons 12, 14 or other control actuators to access shortcuts to, for example, memory 40 or advisor functions 60 can also be provided. In one arrangement, for example, the memory control button 12 can be used to access memory 40 which provides access to store or recall settings and programs, while the shortcut control button 14 can be used to access advisor 60 or other functions which provide, for example, suggested settings for a weld as described below. Although described above as one display, the display 10 can comprise one or more known graphic displays including, for example, an LED or LCD display, OLED displays, one or more multi-segment LED or other lighted displays, a plurality of LED lights, or other combinations of programmable electronic panel displays, or combinations of display elements.

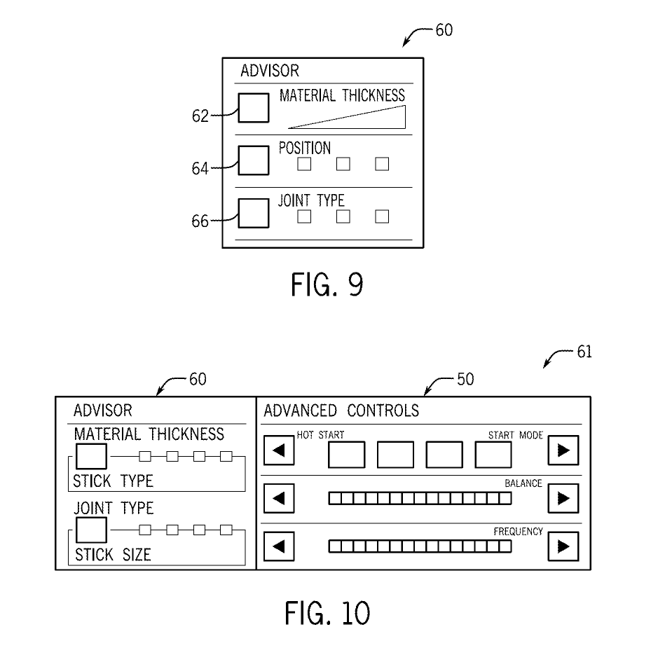

Zone 2: Setup
As used herein, the term setup controls 20 refers to controls that characterize a weld to be run, and which are not changed frequently. Setup controls 20 can include, for example, a selected weld process (MIG, TIG, GMAW-P, Stick, etc.), weld output type (constant current (CC) or constant voltage (CV) on a multi-process machine, and welding polarity (electrode positive (EP) or electrode negative (EN) on an AC machine). Setup can also specify welding materials and consumables, including a type and thickness of material or plate, wire type, and gas type. For wire feeders or integrated MIG machines which include both a power supply and wire feeder within a single housing, the setup controls can also be co-located inside the machine where wire is loaded. Setup controls can be provided, for example, on a switch such as a throw switch, pushbutton, rotary switch, or similar control (FIG. 11A) which provides a signal to the control circuitry in the corresponding controlling welding machine.

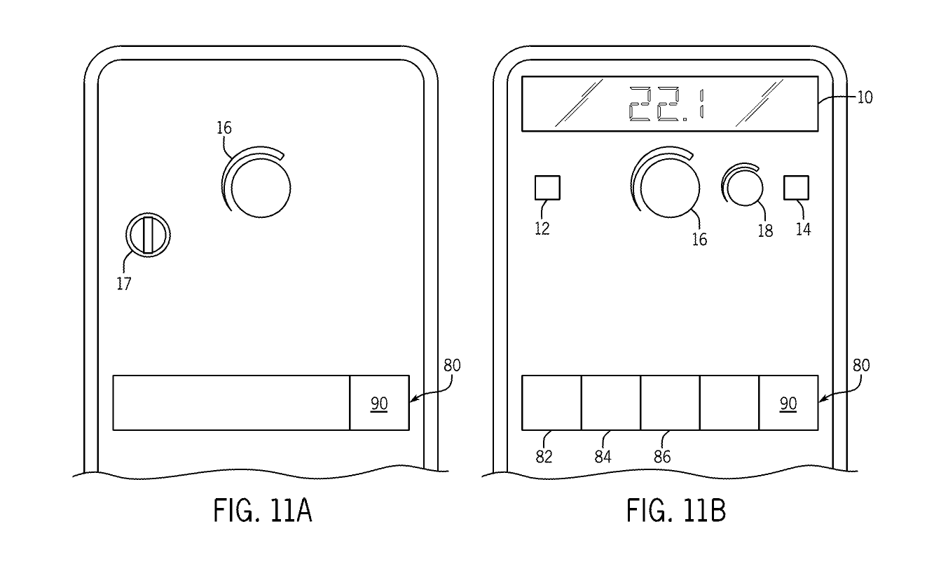

Zone 3: Basic Controls
As used herein the basic controls 30 include fundamental controls that control “heat” and impact the basic ability to lay a weld bead. These controls are typically the most commonly used controls, and are often adjusted during a weld.
In a MIG or GMAW system, the basic controls 30 typically include voltage and wire feed speed. In other types of welding systems, including welding power sources for TIG and Stick processes, amperage is controlled as the most basic control. These controls can also more generically be referred to as “heat controls.” To quickly adjust the heat of a weld irrespective of the type of welding process being used, these controls are grouped together in the basic controls, and should be easily accessible, preferably near the top and center of the interface.
A basic heat control is preferably the largest interface element, with respect to the selected process, and can be centered left to right on the interface. Secondary basic control features, like wire feed speed, are placed to the side of the heat control, such as the right side.
An exemplary “heat control,” is shown in FIG. 6, as knob 16. The term “heat” is commonly used by welders to refer to voltage or amperage, depending on process, and the function of the control will therefore vary by process. Preferably, the heat control is centrally located and is the largest control on the user interface. The main control knob or discrete pushbuttons providing the main control can be large and easy to grab with gloved hands. This control is typically the most frequently used control, and can be used, for example, when the welding system is set to preferred settings, and the operator just needs to lay a bead. The only adjustment may be tweaking of “heat” settings. As shown in FIGS. 4, 6, 11A, 11B, 12, and 13, discussed below, the “heat controls” are typically provided in an analog or digital potentiometer that provides signals to control circuitry in the corresponding weld system.
The control can also provide visual feedback that lets users see the limits of the control and helps relate the output to more than just a number. For example, a segmented radial display can be provided to give a visual depiction of the heat setting. The segmented radial display can show the available range in a first color, for example. A different radial display, highlighted in, for example, a different color, can provide the current setting or advisory features, as discussed below. Numerical identifiers, ranges of colors, and graphics that vary in size can also be used. A display, such as an LED display, can be provided above the heat control to show a numerical value of the heat parameter.
For highly automated equipment the control of basic features may be centered on a different control, such as the advanced controls 50 described below with reference to FIGS. 12-16, through stored memory, or provided through a network or other communications link. In these applications, the basic controls 30 may be unnecessary, and may remain blank on the user interface. Welding control and corresponding interface can, in these applications, be provided in another piece of equipment in the welding system.

Zone 4: Memory
Referring now to FIGS. 1, 3A, 4, and 5, controls for the memory 40 feature can be provided in the upper portion of the interface to enable quick, top-level access. These memory controls can provide functions of both storing and recalling a stored set of values, and can include save to memory and delete functions. The memory feature 40 can be accessed, for example, using the button 12 of FIGS. 4 and 5, which can provide access to internal memory correlated with the control circuitry in the welding system. Various other ways of accessing memory components through electronic displays, memory ports such as USB ports, databases, and other devices will be apparent.
The memory 40 can store control settings such as arc volts, arc current, and wire feed speed that were either selected by or previously used by the welder. The memory 40 could, for example, store settings that were initially selected by use of the advisor 60, or settings that were selected by starting with advisor settings (discussed below) and then specifically tweaked by the welder. Alternatively, the stored data could be selected entirely by the welder. Other operator selected functions, such as “send to trigger select” can correlate stored parameters, such as a program select, with a specific trigger function. In some applications, the memory can also store more advanced weld programs including weld sequencing, and pulse parameters.
Memory 40 can be provided through a single button access (button 12, FIGS. 4 and 5), allowing users to both save and cycle through memory settings, such as program numbers. The memory 40 can be advantageously provided in a prominent portion of the display, such as an upper portion of the interface, and can be positioned consistently provided, for example, at the upper left.
When settings or programs are selected from memory 40, the selected information can be displayed in a prominent portion of the user interface in the display 10, preferably in an upper portion 202 of the interface as shown.
More advanced memory controls may also exist within the advanced zone 50, described below.

The Central Interface Area

Advanced and less commonly used controls and information can be positioned below the upper interface section 202, where they are accessible to the user and visible. These controls are often provided in dynamic interface elements such as LED or LCD displays (FIGS. 12-16, below) and corresponding control selectors which can be provided a part of a touch screen display, or with switches, pushbuttons, or other control actuators. The display can emphasize features that are relevant to the active process, and can turn off or de-emphasize unnecessary features in a way that makes it clear they are not in use. For example, if a pulse feature is turned off, display elements such as pulses per second and frequency can be deactivated. Dynamic backlit labels and clear groupings can be used to help show which controls are relevant to a process. Labels can be positioned adjacent or in close proximately to the appropriate controls, even when the labels are dynamic.

The central portion 204 of the user interface can include the following features.

Zone 5: Advanced
The advanced controls include controls and feedback for advanced welding features, including weld sequencing defining, for example, weld start, weld, and weld end command levels, timing, pressure, pulse parameters, and gas flows. Optionally, these controls can be covered with a panel when not in use (see FIG. 3B), to prevent access by untrained personnel or accidental changed to the parameters, as shown in the general layout figures above.
As used herein, the term advanced welding controls 50 refers to controls that impact the qualities of the weld but typically are not necessary for establishing a weldable condition. These controls can establish weld sequences, and include corresponding timing, and on/off parameters. Functions include timed gas flows, arc pulse parameters, and wire feed parameters. These features can be advantageously grouped based on weld state including start 52, weld 54, and end 56, as described below. Selected data can be stored in internal or accessible external memory, and recalled by the corresponding control circuitry in the system.

### Start

The “start” advanced controls 52 area groups controls that impact the qualities of the arc start and the beginning of the weld. Typical features can include gas preflow time or pressure parameters, touch start or lift arc, wire feed run-in time and speed parameters, and arc start voltage or amperage levels.

Weld
The “weld” control area 54 features include advanced controls that impact the characteristics of the electrical output during a weld. Typical controllable features include arc control (or “dig,” a control which gives a welding power source additional voltage during low voltage or short arc length conditions to avoid sticking), balance (a control which allows a user to adjust the electrode negative versus electrode positive timing in an AC weld), and pulse parameters (current, frequency, and duration).

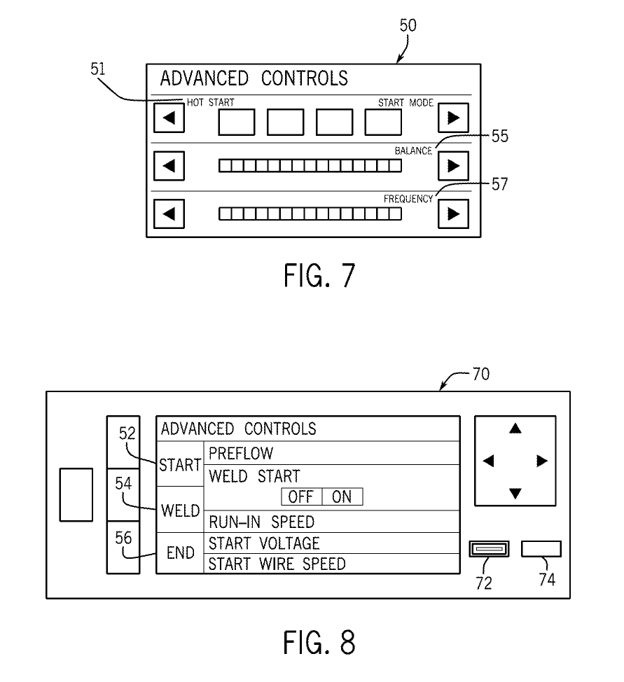

End
The “end” control area 56 features include advanced controls that impact the qualities of the end of the weld. These can include crater fill parameters (adjusting the voltage or amperage while metal fill is delivered to fill a crater at the end of the weld), gas postflow times or pressures, and wire burnback times (maintaining current or voltage for a period of time at the end of the weld to burn back the wire).
Exemplary advanced controls 50 are illustrated in FIG. 7. These controls include features such as “hot start” 51, and “dig”, which allows the user to select between a soft and a stiff arc. These controls can also provide access to high frequency (HF) and lift arc or touch start, and to control features such as balance 55 (typically in a range defined between “cleaning” and “penetration” and frequency 57, which varies the arc between a wider and narrower range in an AC welding power source.
Additional advanced controls 50 are shown in FIG. 8. Here, the start 52, weld 54, and end 56 functions can be illustrated using icons that indicate the portion of the weld affected by the advanced controls in each of these categories. In some applications, colloquial terms familiar to welders (“dig,” “soft,” “stiff”) can be used to guide the user in selecting appropriate settings.

Zone 6: Advisory Information
The advisor 60 can, for example, include one or more interactive display or control to allow a user to select recommended values for weld parameters and smart features. As shown in FIG. 9, the advisor can, for example, set the machine to a weldable starting point based on basic information about the weld such as material thickness 62, position 64, and joint type 66. The advisor can provide graphic illustrations of preferred settings or retrieve settings corresponding to the selected basic information from internal memory or accessible external memory and visually indicate a recommended range of adjustment. Once at this starting point, users can adjust the machine to their personal preferences.
On fully featured machines, the advisor 60 zone may merge with, and form part of the advanced controls 50, providing a single interface 61 including both the advanced controls 50 and advisor 60, as shown in FIGS. 10, and 12. Advisor functions may also, for example, be provided as a voltage or amperage selection printed onto the display around a potentiometer or other control, or provided adjacent the advanced controls as shown below.

Advisor
To simplify the settings of the advisor 60, recommendations are graphically shown directly next to the heat display graphic, and include icons to illustrate visual distinctions between choices. Material thickness 62 can be represented in accurately scaled bars, so that users can compare the thickness of their material to the size of the actual icon. If limited by size constraints, thickness can also be represented in less than ½ scale or greater than 2× to prevent confusion.
Similarly, joint type 66 can be represented with icons for all relevant processes, including, for example, butt, lap, fillet, and corner joints. The advisor 60 can also display a welding process, material, wire, and gas.
A set of icons can also be used to indicate welding position for the advisor feature 60, and can be varied based on process and other parameters. For MIG welding these can include, for example, flat, vertical, and overhead positions.

Zone 7: Machine Management
Referring again to FIG. 8, the machine management zone 70 provides an entry point for machine management features like locks, weld parameter limits and logs. This zone also may contain a slot 72 for a memory card or USB stick to load settings and unlock management features into underlying control circuitry.
As used herein, the term machine management refers to controls related to characteristics of the machine itself, rather than the weld, and can include the ability to adjust factory defaults. The controls for machine management are used infrequently, and can include system preferences, locks, logs calibration, display settings, or units (e.g. metric. vs. U.S.).

The Lower Interface Area

Controls which are used less frequently are preferably positioned in a less prominent location on the user interface. These controls can be positioned in the lower interface area 206 relatively lower than the other controls, and can be advantageously positioned near the bottom of the interface, where they are more closely linked with other machine interactions.

Zone 8: Operational Controls
The operational controls 80, shown in FIGS. 11A, 11B and 12, can include controls that are frequently associated with remote control. These controls can provided by on/off switching elements including toggle switches, pushbuttons, and similar devices which provide signals to internal control circuitry. The controls can be advantageously positioned across a lower portion 206 of the interface near the bottom of the interface where they are closely to the peripheral connections (i.e. torch, remote, ground clamp cables). Not all welding system interfaces will require this section.

As used herein the term operational controls 80 refers to selections for the operator to determine how the operator wants to manage the welding machine and corresponding peripherals. For example, the “trigger hold” function allows the user to lock the trigger of a connected welding gun into an on position when activated, thereby limiting the need to maintain the trigger in an active position. A user may also choose to activate a remote mode, which can allow a user to remotely control the basic controls described above, and other functions, from a welding gun, torch, or other control.
Other operational functions can include “jog,” which allows the user to activate the wire feed motor and feed wire without starting a weld, and “purge” which allows the user to activate the gas valve to clear the line before an actual weld is run. These controls are also often also associated with remote controls.

Zone 9: Power
The power zone 90 includes controls that are necessary to turn the welding power source or other welding machine or system on. These controls can include a power on/off or start switch, or a choke in an engine driven welding power source. These controls are consistently provided in a pre-defined location on the user interface.
Controls for power can be positioned in the lower right hand corner, where the control is clearly visible but out of the way when making or adjusting settings, such as power control 90 shown in FIGS. 11A and 11B. As described above, the power 90 can include a power on/off, start switch, choke, or other actuators, depending on the type of equipment.

The user interface architecture described above can be applied across a wide range of welding equipment of varying capability, providing a familiar interface setup for users across a range of different welding systems. For example, while maintaining the architectural layout described above, the size and capabilities of the interface can be adjusted both for the type of equipment that the interface is positioned on, and the type of equipment the interface is intended to control in the welding system. In some applications, for example, the interface can be sized and dimensioned for inclusion on a wire feeder, remote control, welding torch, welding gun, welding automation control, or other components of a welding system. The interface can be located remotely from the welding power source, but configured to provide control signals to the welding power source and welding system peripherals through a wired or wireless communications interface. A wired interface, for example, can include one or more wires connecting a remote control to a corresponding plug or socket on the welding power source, or can include a communications device for transmitting control signals across a welding cable. Wired interfaces can also include network connections, such as Ethernet connections, internet connections, and various types of large area network and wide area network connections. Wireless communications can be provided through radiofrequency, infrared and other types of communication devices providing signals directly to other welding components of the system, or through various network connections. Various other methods of transmitting signals to the components of a welding system will be apparent.

An interface located remotely on a wire feeder, dedicated remote control device, welding torch, welding gun, welding automation control, or other components of a welding system can be constructed with the general architectural layout described above. In some applications, the remote interface provided at, for example, a welding automation controller, can provide an interface for controlling the power source, a corresponding wire feeder, and other components of the system. When a welding automation controller including an advanced interface is connected to a power source, the interface on the power source can be correspondingly simplified.

In other applications, the main controls for the welding system can be provided at the welding power source. Here, an interface provided on the wire feeder can be selected to provide a subset of available controls. For example, the interface on the power source can include an advanced interface, while the wire feeder can be provided with a single control for adjusting a wire feed speed within a predetermined range.

The interfaces can be constructed as modular components which can be selectively connected and removed from a specific system. For example, a power source with advanced capabilities can be provided with a fully-functioned interface for use in a manual or semi-automatic welding system. When connected to a welding automation controller with a fully functioned interface, the interface in the power source could be disconnected, removed, and replaced with an interface with lower capabilities, such as, for example, a simple heat control allowing an operator to make minor adjustments within a range of heat levels established at the automated welding controller. Other control signals can be provided remotely from the automated welding controller. Software and hardware switches can be provided internally or externally within the system, or through a remote connection, to indicate the type of interface provided on the welding equipment, and to notify an internal processor or control system regarding where control signals originate and where control signals are to be received by the system.

To illustrate various levels of interfaces that can be provided using the architecture described above, exemplary interfaces that represent varying degrees of feature set complexity are described below. For each interface, the appropriate zones are selected for inclusion. The zones are consistently arranged as described above. The selected zones can then be populated with the corresponding operational controls, which can be connected to control circuitry to provide the selected features. As shown here, more complex interfaces can be constructed by adding features and zones to the interface while maintaining the general layout, Less complex interfaces can be constructed by removing or replacing zones with different and less complex features.

Although the interfaces shown here are provided on welding power sources of varying capability levels, as discussed above, it will be apparent that similar interfaces can be provided on wire feeders, remote controls, welding torches, welding guns, welding automation control devices, and other components of a welding system. Further, as discussed above, when the power source is connected to other components of a welding system, the level of interface provided on any piece of welding equipment can be adjusted to provide more or less control, depending on the other components in the system. Communications between the various components of the system can be provided through wired or wireless communications, including wired and wireless networks.

### Example 1

### Basic Interface

In one example, the architecture and layout described above can be advantageously applied to simple, basic, manual or semi-automatic machines, which include a subset of available controls and few or no digital display elements. In these types of machines, there may not be any advanced or machine management control. The number of adjustable components is small enough that designated knobs or buttons can be provided and easily and clearly identified on the interface. The interface typically comprises tangible components, including analog or digital potentiometers or other rotational knob actuators to select ranges of values. The interface can also include on/off switching elements for activating and deactivating functions, or selecting between functions. Display functions, including ranges and limits can be provided by graphics silk-screened or printed on an underlying nameplate, or using multi-segment or other LCD display elements. Although a limited tangible interface is shown, in some applications a more advanced LED or LCD screen with graphic interface capabilities could also be used.

The typical basic interface FIGS. 11A and 11B includes power 90, basic controls 30 that correlate to the type of system (e.g. volts and wire feed speed on display 10 and controls 16 and 18 for a typical constant voltage (CV) MIG welding system, shown in FIG. 11B; amps on control 16 FIG. 11A for a constant current (CC) power source), operational controls 80, if needed (including jog 82, purge 84, and trigger hold 86, as shown in FIG. 11B), and analog advisor controls (printed on the interface and incorporated into ‘heat’ knob 16), and simple setup controls 20 (knob 17 to left of basic controls above, allowing user to select TIG or stick on the CC machine.) Each system typically includes zones 1, 2, 3, and 9 (display 10, setup 20, basic controls 30, power 90) and may also include zones 4 (memory 40) and 8 (operational controls 80). A cover and logo can also be provided as shown in FIG. 3B.

As described above, the basic controls 30 are advantageously centrally located and easily accessed by the operator. Ideally, the basic heat control 16 (amps or volts) includes a digital gauge and display readout in the main display area 10 of zone 1. Alternatively, an analog heat control can be used. Simple advisor controls 60 (such as material thickness) can be integrated with the heat knob 16, and printed onto a nameplate of the interface adjacent the heat control knob 16.

### Example 2

### Intermediate Interface

Referring now also to FIG. 12, in other examples, the architecture can be applied to more complex welding systems, while maintaining the same basic layout, thereby enabling a welding operator to easily move between systems without the need to re-learn the location of basic components. In an intermediate system, the interface typically includes digital display elements, which can be either LCD or LED elements, including on/off lights 92 indicating selected types and sizes, and bar graph range indicators 93. On/off switches or other controls, rotational controls providing an analog range (as shown by the heat selector 16) or providing a selection between a number options (process selection 17 between AC TIG, DC TIG, and Stick, above), and switches or other controls, including power switch 90 for activating or deactivating the power supply, and operator controls 82, 84, 86 or to activate remote functions. The remote functions can include, for example, jog, purge, trigger hold, or other functions as described above with reference to FIG. 11B Although a more traditional interface is shown, a graphical user interface or touch screen could also be used.

This intermediate level of interface can be advantageously applied, for example, to single process machines with more advanced features sets than those described above. The intermediate level of interface can also be applied, for example, to multi-process machines with a similarly limited set of features to those described above. A typical intermediate interface can include, for example, main display 10, power 90, basic controls 30 (including memory 12, heat 16), and operational controls 80. The interface may also include simple setup controls 20 (process sections such as AC TIG, DC TIG, and stick, as shown as switch 17 for the CC power source in FIG. 11A), an advisor 60, providing weld starting points for defined material types and thicknesses, or stick type and size (as shown) and advanced controls 50, which, as described above, can include hot start and dig controls for a CC machine, and weld sequencing including preflow, postflow, and other parameters for a MIG machine. A simple memory 40, accessible through memory control 12, may also be provided for recalling selected weld parameter settings developed by the user or the advisor function.

In an alternate embodiment, a similar system for a CV MIG, Pulse, or multi-process system could include, for example, CC/CV select as part of the setup controls, advisor functions allowing a user to specify material type and thickness, wire type and thickness, and/or gas type, and provide recommended weld parameter settings. Setup could also allow a user to choose to select jog, purge, or program select functions from a remote control, and provide recommended weld parameter settings. The intermediate interface, therefore, will typically include Zones 1-6 & 8-10, as described above.

In both configurations, the basic controls remain in a location where they are easily accessed by the user, and the display remains positioned in an upper portion 202 of the interface, providing easy access to process, memory and weld parameter information and settings.

The advisor functions 60 can be digitally linked to the basic controls 30 including heat control 16, and hard selector activators or buttons can be mapped directly to the controls they are adjusting. A display, such as a segmented display or a dynamically backlit membrane panel, can reside in the advanced control 50 and advisor sections 60, Zones 5 and/or 6. As a result, some dynamic content can be dependent on preset chunks of information. A hinged protective cover can protect and hide either all or portions of the display. FIG. 3B, for example, schematically illustrates a cover provided over a central portion 204 of the interface.

### Example 3

### Full-Featured Interface

Referring now also to FIG. 13, a full-featured interface includes the ability to fully control the welding equipment using the zones described above, including power 90, main display 10, basic controls 30 (16, 18), operational controls 80, full setup controls, advisor 60, full memory capabilities 40, advanced controls 50, and machine management controls 70 (72, 74).

The interface therefore includes similar core controls to the intermediate interface described above, but can also include features such as a full-resolution, pixel-based display capable of providing multiple levels of dynamic information for multiple processes and features. The basic heat control again continues to be maintained where a user would find it in a lower level model, as part of the central control, with advisor capabilities digitally linked to the control in internal control circuitry.

A designated machine management control 74 can be provided directly on the interface, but is relatively small in size, and provided in a side location, where it receives limited visual emphasis to discourage users from adjusting the settings. As described above, a hinged protective cover can protects and hides a portion or all of the display.

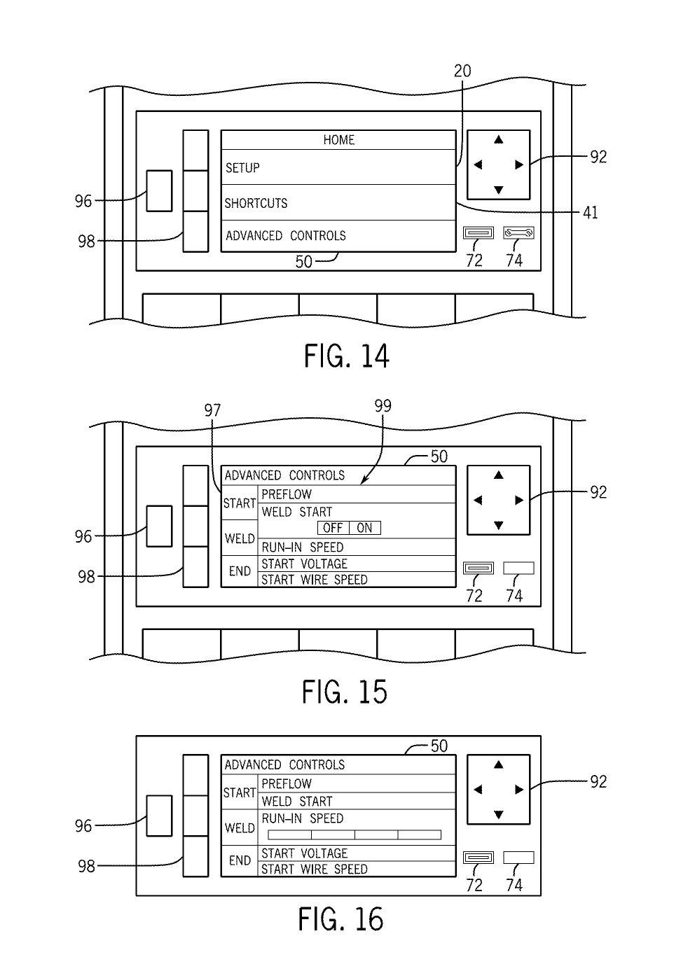

Referring now to FIGS. 13-16, in one embodiment, a full display 94 resides in the central interface area 204, including the advanced controls 50 of zone 5. The display 94 enables dynamic content for setup, shortcuts (advisor and memory functions), advanced settings, and machine management. Referring to FIG. 14, these controls can be arranged to provide access to more frequently accessed controls, providing setup 20 as a top selection on the display, and advanced controls 50 further down, in accordance with the layout described above with reference to FIGS. 3A and 3B. A hard home button 96 can be provided to return the user to an overview screen, while a navigation control 92 enables many types of user-entered content and easy movement through displays. As shown here, a 4-way navigation control 92 can be used. Five way navigation, and various other types of multi-dimensional navigation systems can also be used. The display 94 can be a pixel-based thin film transistor (TFT) LCD display. Alternatively or in addition to the TFT display, various types of electronic displays, including LED, touch screen, plasma, and other types of devices can also be used.

The display 94 can provide an advanced graphical user interface, as shown in FIG. 14. In these types of applications, a menu is provided to access underlying functions, and can advantageously be structured to allow users to easily navigate to available features of a machine to access weld selection data, so that users are not required to memorize a path to a particular control adjustment or activation location. The ‘home’ button 96 can function like an escape button in typical computer systems, allowing the user to return to a known location, and providing a consistent starting point with a clear overview.

When an advanced display of this type is used, it's important to always show the user where he/she is. Therefore, a typical display can be limited to three layers of depth, including: meta-category, sub-category, and parameter list. This structure results in two types of screens and interactions for a user to learn: category selection and parameter adjustment.

In one embodiment, shown in FIG. 14, the interface can include three meta-categories that appear on the home screen: setup 20, shortcuts 41, and advanced controls 50. As discussed above, the menu can be configured to provide more frequently accessed functions at the top (setup 20) and less frequently accessed functions further down (advanced controls 50), consistent with the layout described above where the setup 20 is typically provided in an area of the interface above the advanced controls. These menu choices can be coded or highlighted for the user. For example, red can be assigned to set-up functions, blue to shortcuts, and white to advanced controls. Hard wired selector controls 98, such as buttons or other activators, can be provided to the right and left of the screen, and can provide the function of selectors of these meta-categories. In one example, selecting the setup category 20 provides subcategory options of process, materials, and consumable. When the process sub-category is selected, the parameters of MIG, TIG, GMAW-P, and Stick can be presented for selection by the user.

As described above, Machine Management options 70 are preferably accessible but out of the way, and provided in a dedicated hard button 74 adjacent the screen (e.g. to the left or right of the screen), as can be shown, for example, by a “wrench” icon (FIG. 14). As described above, a Universal Serial Bus (USB) or other data port 72 can be provided adjacent the machine management 74 to provide access to easily unlock access to the management functions, and to quickly and easily upload and download data.

As shown in FIGS. 15 and 16, once inside a meta-category, a user can move between sub-categories 97 (start, weld, end) using controls on the periphery of the screen, such as the hard buttons 92, 96 and 98 adjacent (to the left or right of the display). Each sub-category contains a corresponding list of adjustable parameters 99. Here, preflow, weld start, run-in speed, start voltage, and start wire speed corresponding to the weld start sub-category of the sub-categories 97. As described above, in one application, a four-way navigation button 92 providing up/down and right/left controls is provided on the right of the screen, and allows a user to navigate lists and adjust settings up and down to select a parameter, while left and right adjust it's value. The selected sub-category and alternatives can be visible while scrolling through lists and adjusting values. When a user selects and adjusts the adjustable parameters, the data can be transmitted to and stored for use by control circuitry in the welding equipment.

Features can also be locked out to limit access by selected users, and require a key, password, or pass code to change parameters. For example, on some welding systems and in some applications, the machine management controls 70 can be selectively locked so that access to adjust machine management selections is permitted only for authorized users. Again, a USB or other data port 72 can be provided both for locking and unlocking access to the limited features, and to load and unload data.

As described above, in the display structure, the user is provided with a visual display of the entire range of possible selections, and a clear indicator of the advised and selected positions. Colloquial language (“less stubbing”) can be used to more clearly convey the effect of a selection to a user. A “smart” selection can be provided to optimize parameters based on user input data from “setup” 20 and “advisor” 60, in addition to a manual selection.

The present invention therefore provides a number of advantages over prior art welding interface devices. A predetermined system architecture and layout can guide the organization of the interface, such that relationships and hierarchy are consistent between machines, and improving efficiency of access to settings and information. A home key 96 (FIGS. 13-16) provides an escape to familiar comfortable ground. Users can therefore more easily move between machines, transition between processes, and discover new capabilities.

In one aspect, an interface constructed in accordance with the principles of the present invention provides a clear and consistent hierarchy of controls, and clear starting points for identifying useable welds, enabling welders to move between simple and complex machines easily, with at least a basic understanding of how to easily establish a weldable condition, and how changes will affect a weld. Types of controls are arranged in defines zones, and a consistent layout of these zones enables users to quickly locate and adjust weld parameters and other data. Each of the zones is arranged on the interface and can selectively receive controls to provide control signals to internal circuitry to adjust parameters, change settings, and store and recall memory data. The complexity of these controls can vary from basic potentiometers and switching elements, to advanced graphical displays, and be provided in combinations of these elements. Ready access to memory components in the system is also provided.

In another aspect, the interface improves efficiency by communicating weld parameters in terms of the desired output, thereby enabling welders to operate using terms they know, and reducing confusion. The interface of the present invention further clarifies how different parameters affect the outcome, and provides access to features to encourage exploration. The interface described above also provides simple defined access to memory storage, enabling the capture and preservation of learned experiences after exploration.

In yet another aspect, the interface of the present invention can associate clear boundaries and ranges with welding parameters, enabling quick refinement and adjustment that enable welders to perform better and more efficiently.

In still another aspect, the interface described herein can be constructed modularly, and easily interconnected with existing interface elements to change the features of a welding machine while maintaining a consistent organization. Each of the interface zones can, for example, be provided as separate components, or grouped together, and interconnected to underlying control circuitry to create or change the interface in a system. The interface can be advantageously applied across ranges of welding equipment, and easily modified to provide an array of varying features while maintaining a consistent organization for users. Various levels of control elements, ranging from traditional hard wired controls to interactive displays, can also be advantageously provided in the corresponding zones.

It should be understood that the methods and apparatuses described above are only exemplary and do not limit the scope of the invention, and that various modifications could be made by those skilled in the art that would fall under the scope of the invention. For example, although the examples above illustrate a user interface on a welding power source, the interface of the present invention can be applied to any of a number of different types of welding machines and equipment. Additionally, although a specific layout is described above, the layout can be varied consistent with the general principles described above. To apprise the public of the scope of this invention, the following claims are made:

1. An architecture for a user interface for use in welding equipment, the architecture comprising:
a main display zone;
a basic controls zone;
an advanced controls zone;
an advisory information zone;
an operational controls zone; and
a power zone,
wherein the main display and basic controls zones are provided in an upper interface portion to provide easy access to view and change weld heat data,
the advanced control zone and the advisory information zone are provided in a central interface portion below and adjacent the upper interface portion; and
the operational controls zone and the power zone are located in a lower interface portion below and adjacent the central interface portion, and
wherein a power control is provided in the power zone in the lower interface portion and the lower interface is adapted to selectively receive an operational control in the operational control zone; the central interface is adapted to selectively receive at least one of an advisor control in the advisory information zone, and advanced control in the advanced control zone, and a machine management control in the machine management zone; a heat control is provided in the basic controls zone in the upper interface zone, and the upper interface zone is adapted to selectively receive a display element in the main display zone.

2. The architecture of claim 1, further comprising a setup zone provided in at least one of the upper interface area and the central interface area, and the interface is adapted to receive a setup control in the setup zone.

3. The architecture of claim 1, further comprising a memory zone provided in the upper interface area and adapted to receive a memory control for accessing weld parameter settings.

4. The architecture of claim 1, further comprising a machine management zone provided in a central portion of the display, the machine management zone being adapted to receive a machine management control providing access to at least one of a weld parameter limit, a log and a lock.

5. The architecture for a user interface as recited in claim 1, wherein the main display zone comprises at least one of a graphic and an interactive display element for displaying a weld heat parameter.

6. The architecture for a user interface as recited in claim 2, wherein the setup control comprises a control selector to identify at least one of a material, a material thickness, a consumable, or a position to be used in a weld.

7. The architecture for a user interface as recited in claim 1, wherein the advisor control is adapted to receive user input identifying a weld to be performed, to access stored data in an internal memory, and to provide a recommended weld parameter corresponding to the identified weld.

8. The architecture for a user interface as recited in claim 1, wherein the welding equipment comprises at least one of a welding power source, a wire feeder, a remote control device, a welding gun, a welding torch, and a welding automation controller.

9. The architecture for a user interface as recited in claim 1, wherein the basic control comprises a control knob substantially centered in the upper portion of the interface and adapted to be adjusted by a user to change a weld heat of a corresponding weld power source.

10. A user interface for use in welding equipment comprising:
an electronic display for displaying weld selection data in a primary metadata level, a secondary sub category level, and a tertiary parameter level, each weld selection in the sub category corresponding to at least one corresponding weld selection in the metadata level, and each weld selection in the tertiary parameter level corresponding to at least one weld selection in the corresponding sub category level;
a selector control activatable by a user to selecting a weld selection in the electronic display; and
a home button activatable by a user to selectively return the electronic display to the primary level metadata.

11. The user interface of claim 10, further comprising a navigational device activatable by the user for moving through the primary metadata level, the secondary sub category level, and the tertiary parameter level and corresponding weld selection data in the electronic display and identifying a weld selection datum for selection by the selector control, the navigational device being positioned adjacent the electronic display.

12. The user interface of claim 11, wherein the navigational device comprises a multi-directional switch positioned adjacent the electronic display, each of the positions of the multidirectional switch corresponding to a selected direction of movement in the electronic display.

13. The user interface of claim 11, wherein the multi-directional switch comprises four positions, the four positions corresponding to an up direction, a down direction, a right direction, and a left direction activated to indicate movement through the interface.

14. The user interface of claim 10, wherein the user interface includes an upper interface area, and a central interface area positioned below the upper interface area, and wherein the upper interface comprises at least one heat control knob adapted to provide a signal to internal circuitry to adjust a heat of a weld produced by the welding equipment.

15. A user interface for a welding system, the user interface comprising:
an upper portion comprising a heat control and at least one of a user display, a memory component, and a setup control;
a central portion comprising at least one of an advanced control for weld sequence data, and an advisory control for providing a suggested weldable condition to a welder; and
a lower portion comprising at least one of an operational control for providing remote functions for a welding power source or a peripheral component and a power control for activating the welding system.

16. The user interface of claim 15, wherein the heat control comprises at least one of a voltage control, a wire feed speed control, and an amperage control.

17. The user interface of claim 15, wherein the advisory control provides a recommended heat setting based on user input of at least one of a material type and a material size.

18. The user interface of claim 15, wherein the advanced control includes an interface allowing a user to select at least one of a start, a weld, and an end weld condition.

19. The user interface of claim 15, wherein the central portion comprises a graphical user interface.

20. The user interface of claim 15, wherein the operational controls comprise at least one of a jog activator, a purge activator, and a trigger hold activator.
